(19) United States
(12) Patent Application Publication
(10) Pub. No.: US 2005/0044075 A1
(43) Pub. Date: Feb. 24, 2005

(54) Method and apparatus for late-binding/dynamic pathname resolution

(75) Inventors: David C. Steere, Bellevue, WA (US); Brian Dewey, Seattle, WA (US); Rajeev Nagar, Sammamish, WA (US); Vishal V. Ghotge, Bellevue, WA (US)

Correspondence Address: MICROSOFT CORPORATION;C/O MERCHANT & GOULD, L.L.C., P.O. BOX 2903, MINNEAPOLIS, MN, 55402-0903, US

(73) Assignee: Microsoft Corporation, Redmond, WA (US)

(21) Appl. No.: 10/630,130

(22) Filed: Jul. 29, 2003

(51) Int. Cl. G06F 7/00

(52) U.S. Cl. 707/4

(57) ABSTRACT

Late-binding/dynamic pathname resolution can be performed by a variable identifier operating in user or kernel mode, and a pathname engine and a data structure operating in kernel mode. The variable identifier identifies a variable in a pathname. The pathname engine evaluates the variable by converting the variable into a character string such that a path to an object file is established. The pathname engine determines a scope of potential character string values for the variable by mapping the variable to corresponding values stored in the data structure. Each variable has a well-defined scope of values because the only values available are the values selected for storage in the data structure. The mechanism for establishing values is extensible such that variable/value pairs can be implemented in the data structure at any time.

### FIELD OF THE INVENTION

The present invention relates to computing systems, and more particularly to pathnames identifying a location of a resource stored on a computing system.

### BACKGROUND OF THE INVENTION

In computer operating systems, a pathname is a sequence of alphanumeric characters that identifies the location of a file or directory. The simplest type of pathname is the name of the file itself. The operating system looks for a file in the current working directory when the pathname is specified by the filename. If the file resides in a different directory, a path is specified such that the operating system can locate the file. The process of translating a pathname into operating system language is known as pathname resolution.

One problem with existing systems is that pathnames are essentially static. There is currently no mechanism for pathname components that are customizable or evaluated in the context of a user of the path. Once a pathname has been created, that same pathname will resolve to the same data regardless of which user is logged on, which machine the pathname resolution occurs on, or the like. This limitation has plagued computer system users and designers for some time.

A mechanism for dynamic pathname resolution has, until now, eluded those skilled in the art.

### SUMMARY OF THE INVENTION

In accordance with one aspect of the present invention, a computer-readable medium, having computer-executable components, includes a data structure including variable/value mappings and a pathname resolver. The pathname resolver is configured to identify a variable in a pathname, to retrieve from the data structure a value associated with the identified variable, and to modify the pathname such that the variable is replaced with the value from the data structure.

In accordance with another aspect of the present invention, a computer-readable medium has computer-executable instructions. The computer-executable instructions include: receiving a pathname that includes a variable; resolving the pathname by mapping the variable to a corresponding value in a data structure; returning a handle to an object pointed to by the resolved pathname; and expanding the data structure by adding variable/value pairs to the data structure.

In accordance with yet another aspect of the present invention, a computer-readable medium is encoded with an extensible data structure. The extensible data structure includes a first field and a second field. The first field includes an identification of a variable included in a pathname. The second field includes a value for the variable. The pathname includes the value that is operable to point to an object.

In accordance with still yet another aspect of the present invention, a computer-implemented method includes: identifying a variable in a pathname provided by a component requesting access to an object; mapping the variable to a corresponding value in a data structure; modifying the pathname by replacing the variable in the pathname with the corresponding value such that the resolved pathname creates a path that points to the object; and returning to the requesting component the modified pathname.

### BRIEF DESCRIPTION OF THE DRAWINGS

FIG. 1 illustrates an exemplary computing device that may be used in one exemplary embodiment of the present invention.

FIG. 2 is a block diagram illustrating an exemplary environment for practicing the present invention.

FIG. 3 is a logical flow diagram of an exemplary overview of a pathname resolution process performed in accordance with the present invention.

FIG. 4 is a logical flow diagram of an exemplary overview of a data structure expansion process performed in accordance with the present invention.

### DETAILED DESCRIPTION OF THE PREFERRED EMBODIMENT

Briefly stated, the present invention is related to a method and system for late-binding/dynamic pathname resolution. The pathname resolution can be performed by a variable identifier, a pathname engine, and a data structure. At the time of request for access to an object by pathname, the variable identifier identifies a variable in the pathname. The pathname engine evaluates the variable by referring to a data structure having variable/value mappings. The data structure may be stored in the context of the current user. The pathname engine modifies the pathname by replacing the variable in the pathname with its corresponding value from the data structure and returns the modified pathname.

The invention will be described here first with reference to one example of an illustrative computing environment in which embodiments of the invention can be implemented. Next, a detailed example of one specific implementation of the invention will be described. Alternative implementations may also be included with respect to certain details of the specific implementation. It will be appreciated that embodiments of the invention are not limited to those described here.

Illustrative Operating Environment

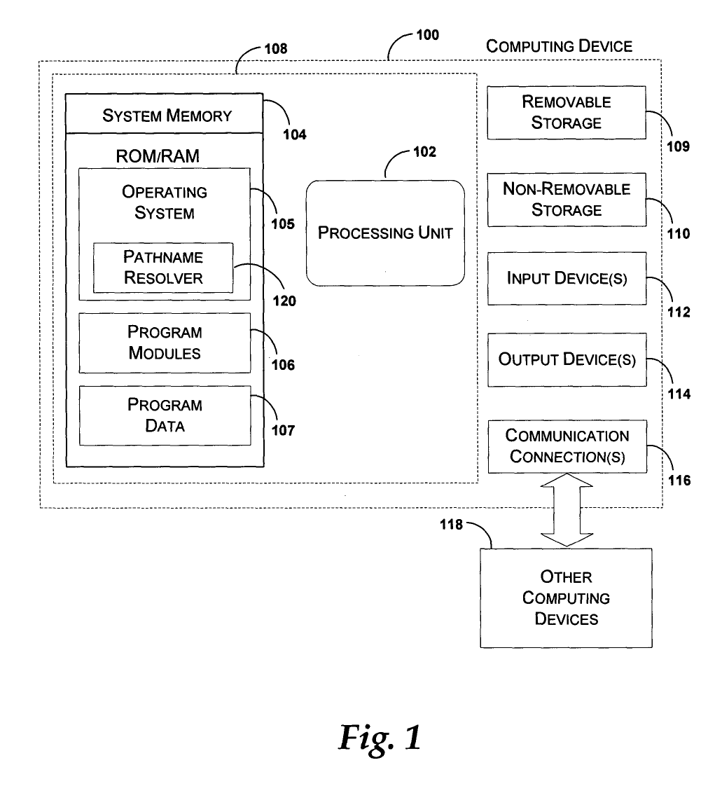

With reference to FIG. 1, one exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more program modules 106, and may include program data 107. The operating system 105 can further include a pathname resolver 120 according to the present invention. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well know in the art and need not be discussed at length here.

Computing device 100 may also contain communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Structure of Pathname Resolver

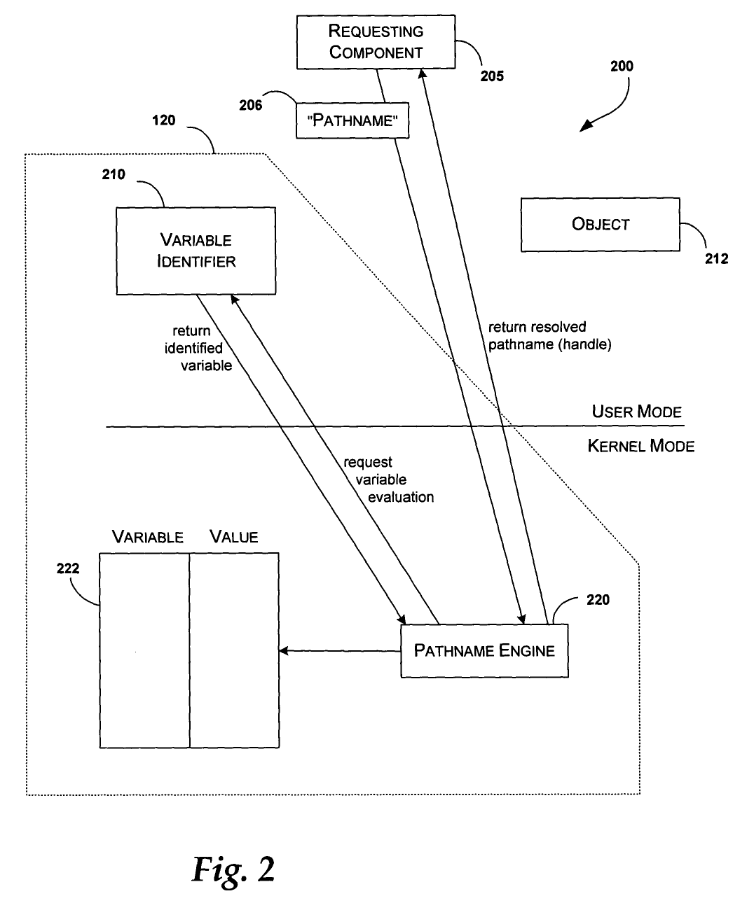

With reference to FIG. 2, a block diagram illustrating an exemplary environment for practicing the present invention is shown. The exemplary environment shown in FIG. 2 is a path/link subsystem environment 200 for a file system that includes pathname resolver 120 according to the present invention. The environment includes a requesting component 205, which may be any component that requests access to an object (e.g., object 212) by a pathname 206. For example, the requesting component 205 may be any one or more of the following: embedded paths or uniform resource locators (URLs) in an e-mail message; and paths having variables included in scripts.

In this embodiment, the pathname 206 used to refer to the object 212 includes a variable. For instance, one example of such a pathname may be “\\server\share\@user\phonelist.doc”. In this example, the term “user” is identified as a variable through the use of the “@” character. Other characters may also be used.

Pathname resolver 120 includes variable identifier 210, pathname engine 220, and data structure 222. In this particular implementation, the variable identifier 210 operates in user mode, and the pathname engine 220 and the data structure 222 reside in kernel mode. Pathname engine 220 is responsive to requesting component 205 and requests variable evaluation from variable identifier 210. Alternatively, requesting component 205 communicates directly with variable identifier 210 to request variable evaluation.

The variable identifier 210 identifies the variable in the pathname 206. In this particular implementation, the variable is identified by locating a unique prefix in the pathname 206, the “@” character in this example. The unique prefix could be any combination of one or more characters. Variable identifier 210 returns the identified variable to the pathname engine 220.

The pathname engine 220 evaluates the variable by referring to the data structure 222. The data structure 222 stores a number of variable names mapped to corresponding values. The values may be character strings, or may reference or point to arbitrary executable code that results in a string. The pathname engine 220 searches for the variable in the data structure 222. A corresponding value will only be found if a value has been stored in data structure 222, thus each variable has a well-defined scope of values because the only values available are the values stored in the data structure 222. If the variable does not exist in the data structure 222, the pathname is identified as a character string rather than a pathname including a variable. This allows legal characters to be used as the prefix that identifies variables. Alternatively, illegal characters could be used to identify variables, in which case if a variable did not exist in the data structure 222, an error could be returned.

If a proper value for the variable exists in the data structure 222, that value is returned to the pathname engine 220. The pathname engine 220 may then modify the pathname 206 provided by the requesting component 205 by replacing the variable with the value of the variable. In this way, the modified pathname points to the object 212. The pathname engine 220 may then request that the modified pathname be resolved into a handle for the object 212 and return that handle to the requesting component 205.

In one embodiment, the data structure 222 may be unique to each user such that a different user has a different set of variable/value mappings. This allows a textually-identical pathname (including a variable) to map to different objects based on which user is logged on. For example, if a variable such as “@username” is used in a dynamic pathname, that variable would evaluate to a different value based on which users were logged on to the computing system. In another example, a variable such as “@L-146” may refer to an office location. That variable may be used in a pathname that identifies a printer within that office, but which has a name based on the current occupant of the office. Accordingly, a data structure 222 may include a table that maps the office location variable to a username of the current occupant of that office. Many other alternatives will also become apparent to those skilled in the art.

In this implementation, any privileged application could write values and/or variables to the data structure 222, thus making this mechanism extensible. Alternatively, the data structure 222 could be fixed in size with a finite number of values such that values cannot be added arbitrarily. Unique variables could be defined in data structure 222 having a scope of potential values determined by the requirements of file system 200.

The values corresponding to the variable can be defined in many ways. For example, the values can be user-defined or the values can be context specific (e.g., the values can be defined by the state of the operating system or environment). Some basic values can be provided that are widely used such as values corresponding to a variable defined as “user.”

Process for Late-Binding/Dynamic Pathname Resolution

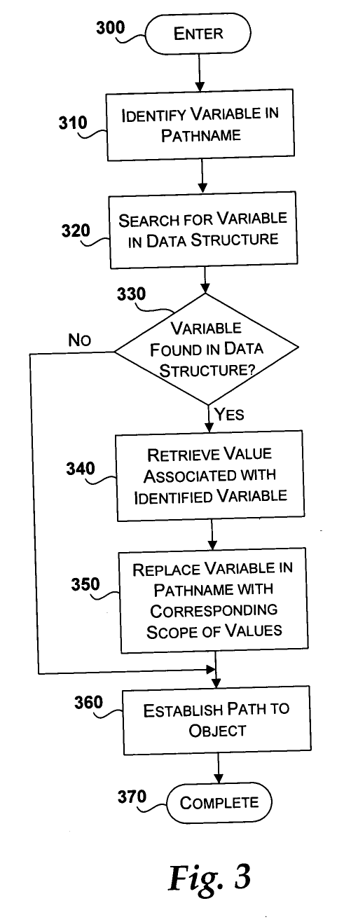

With reference to FIG. 3, a logical flow diagram of an exemplary overview of the pathname resolution process performed in accordance with the present invention is shown. The process enters at starting block 300, where a requesting component has requested access to an object identified by a pathname. The process continues at block 310.

At block 310, a variable is identified in the pathname. The variable can be identified by parsing the pathname into its constituent parts and searching for a unique prefix character, e.g. “@”. If a variable is found the process continues at block 320.

At block 320, a search is performed for the variable in a data structure, such as a table with variable/value mappings. At decision block 330, a determination is made whether an entry for the variable is found in the data structure. If the variable is found in the data structure, the process proceeds to block 340. If the variable is not found in the data structure, the process proceeds to block 360 where the variable is treated as a character string not requiring resolution.

At block 340, the value associated with the variable is retrieved from the data structure and the process proceeds to block 350. At block 350, the variable in the pathname is replaced with the corresponding value to form the complete pathname, and the process proceeds to block 360. At block 360, the complete pathname is returned to the requesting component. The process proceeds to block 370 where the pathname resolution is complete.

Process for Adding Variable/Value Pair to Data Structure

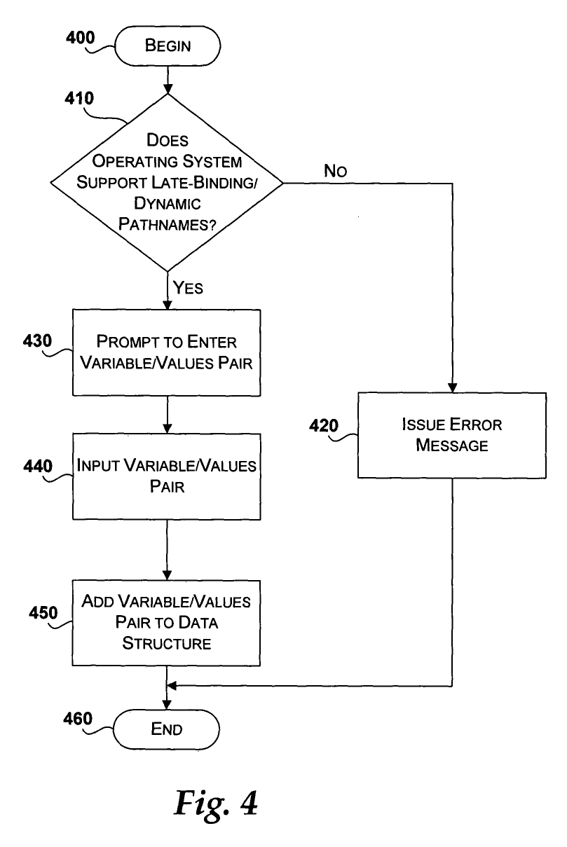

With reference to FIG. 4, a logical flow diagram of an exemplary process for expanding the data structure performed in accordance with the present invention is shown. The data structure can be expanded by adding new variable/values pairs.

The process begins at block 400 where a system administrator decides to include more variables and/or corresponding values to the data structure. At decision block 410, a determination is made whether the operating system supports late-binding/dynamic pathnames. If the operating system supports late-binding/dynamic pathnames, the process proceeds to block 430. If the operating system does not support late-binding/dynamic pathnames, the process proceeds to block 420. At block 420, an error message is issued informing the system administrator that the operating system does not support late-binding/dynamic pathnames, and the process proceeds to block 460.

At block 430, the system administrator is prompted to enter a variable/value pair. The process proceeds to block 440. At block 440, the system administrator inputs a variable/value pair into the system. The process proceeds to block 450. At block 450, the variable/value pair is added to the data structure. The process ends at block 460.

It will be appreciated that adding variable/value pairs to data structures in accordance with the invention may also be performed by script, such as at user logon.

In addition, policies may be set that include pre-defined variable/value mappings.

Likewise, a software component having sufficient permissions to alter a data structure in protected mode may directly access and modify variable/value mappings in the data structure. In this way, variable/value mappings may be created that are resolved in the context of a particular user, particular hardware or software on which the several components execute, or based on some other criteria.

The above specification, examples and data provide a complete description of the manufacture and use of the composition of the invention. Since many embodiments of the invention can be made without departing from the spirit and scope of the invention, the invention resides in the claims hereinafter appended.

1. A computer-readable medium, having computer-executable components, comprising:
a data stature including variable/value mappings;
a pathname resolver configured to identify a variable in a pathname, to retrieve from the data structure a value associated with the identified variable, and to modify the pathname such that the variable is replaced with the value from the data structure.

2. The computer-readable medium of claim 1, wherein the pathname resolver comprises a variable identifier that is configured to identify the variable in the pathname.

3. The computer-readable medium of claim 1, wherein the pathname resolver comprises a pathname engine that is configured to identify the variable by performing the following steps:
searching for the variable in the data structure;
accessing the corresponding value; and
inserting the value in place of the variable in the pathname such that the path identifies the location of an object.

4. The computer-readable medium of claim 1, wherein the data structure is implemented in a kernel mode of an operating system.

5. The computer-readable medium of claim 1, wherein variable/value pairs are defined in the data structure by a user.

6. The computer-readable medium of claim 1, wherein variable/value pairs are defined in the data structure by a context in which the computer-readable medium operates.

7. A computer-readable medium having computer-executable instructions comprising:
receiving a pathname that includes a variable;
resolving the pathname by mapping the variable to a corresponding value in a data structure;
returning a handle to an object pointed to by the resolved pathname; and
expanding the data structure by adding variable/value pairs to the data structure.

8. The computer-readable medium having computer-executable instructions of claim 7, further comprising identifying the variable in the pathname.

9. The computer-readable medium having computer-executable instructions of claim 8, further comprising searching for the variable in a data structure implemented in the kernel of an operating system.

10. The computer-readable medium having computer-executable instructions of claim 9, further comprising inserting the value corresponding to the variable in place of the variable in the pathname.

11. A computer-readable medium encoded with an extensible data structure comprising:
a first field including an identification of a variable included in a pathname; and
a second field including a value for the variable, the pathname including the value being operable to point to an object.

12. The computer-readable medium encoded with an extensible data structure of claim 11, wherein the data structure is stored in the kernel of an operating system.

13. The computer-readable medium encoded with an extensible data structure of claim 11, wherein the data structure is expandable by adding variable/value pairs.

14. A computer-implemented method, comprising:
identifying a variable in a pathname provided by a component requesting access to an object;
mapping the variable to a corresponding value in a data structure;
modifying the pathname by replacing the variable in the pathname with the corresponding value such that the resolved pathname creates a path that points to the object; and
returning to the requesting component the modified pathname.

15. The computer-implemented method of claim 14, further comprising receiving a pathname that includes a variable.

16. The computer-implemented method for resolving a pathname of claim 14, further comprising searching for the variable in the data structure implemented in the kernel of an operating system.

17. A computer-readable medium with computer-executable instructions for performing the method of claim 14.
